(19) United States
(12) Patent Application Publication
(10) Pub. No.: US 2010/0325027 A1
(43) Pub. Date: Dec. 23, 2010

(54) Method and Apparatus for Automatically Generating Trading Instructions and Executing Trading

(76) Inventor: Frank Otto Schloer, Nueva Andalucia (ES)

Correspondence Address: IP STRATEGIES, 12 1/2 WALL STREET, SUITE E, ASHEVILLE, NC, 28801, US

(21) Appl. No.: 12/160,395

(22) PCT Filed: Jan. 9, 2007
(86) PCT No.: PCT/EP2007/000119

§ 371 Date: Aug. 26, 2010

(30) Foreign Application Priority Data
Jan. 12, 2006 (DE) 10 2006 001 558.4

(51) Int. Cl. G06Q 40/00

(52) U.S. Cl. 705/37

(57) ABSTRACT

Method and apparatus for automatic trading with a module for generating instructions and an automatic trading module wherein trading-relevant data of an extensive environment are registered, trading strategies determined, and the definition of the volume of a trading as well as the execution of a trading carried out basically without human assistance.

### BACKGROUND OF THE INVENTION

Until not so long ago instruments of commercial character like, for example, foreign currencies or forward interest trading contracts were traded via voice brokers. Jobbers have called their voice broker on the phone concerning a demand or an offer and the broker tried to find a match with a contractual partner. In doing so the voice broker did not necessarily disclose the identity of the contractual partner in this earliest stage of the deal in preparation but was merely seeing to it that each of the partners was able to grant to the other sufficient lines of credit so that the deal could be made. In those cases in which a jobber traded frequently via a broker that broker gained knowledge as to with which contractual partners the jobber held a credit line and was, therefore, able to enquire on an empiric basis or filter out offers he knew about in consideration of his business experience.

With the emergence of computerized trading systems the importance of voice brokers decreased and many of the deals made were executed via anonymous trading systems or electronic dialogue-supported systems which tried to imitate the role of the voice broker.

In the following period a number of anonymous trading systems were submitted and introduced into the market. Here, only those institutions are able to deal, however, which have installed such a system with the deals being limited to the credit amount that was allocated to these particular deals. The object underlying the trading system known from DE 102 97 153 T5 is therefore to incorporate voice broker functions in an electronic or anonymous trading system.

This object is accomplished according to the details in claim 1 by a computerized trading system for trading instruments between trading partners with a communications network for communicating electronic messages with the following characteristics:

A plurality of jobber-order entry apparatuses which are connected to the communications network, each for generating electronic orders including enquiry and/or quotation orders, and for the communication to jobbers of order information received from other entry apparatuses over the network; as well as at least one jobber-order entry apparatus which is connected to the communications networks for generating electronic orders, including enquiry and/or quotation orders in the name of a selected one, of a plurality of agent jobbers and for the communication with a broker of order information received from other entry apparatuses via the network; as well as at least one matching machine which is connected to the network for matching enquiry and quotation orders entered into the system by the order entry apparatuses and for making deals, with prices being aligned, and a market distributor which is connected to the network for distributing order price messages to the order entry apparatus, the market distributor being responsible for the order messages and the matching machine.

As a further development a trading system for the automatic posting of buying or selling orders for selected security papers by an intelligent machine according to the teachings from U.S. 2005/0015323 A1 is known from the state of the art (compare Claim 1 on this).

These orders are posted according to self-optimized trading strategies and trading parameters out of the jobber's computer to computer-equipped trading centers, the system featuring the following modules:
a) a data feed module which receives currently valid or historical trading data of a multiplicity of security papers from a remote data server,
b) a trading software module as a means for the development of a trading strategy which generates optimum and/or self-optimized buying/selling trading instructions, these being based on a number of optimized trading parameters,
c) a module with a mechanism in the manner of an intelligent machine which uses shortly optimized buying/selling instructions and their trading result as input parameters for the generation of new buying/selling instructions, these being based on new and edited trading results, trading data and trading parameters,
d) an automatic execution platform as a means for communicating self-optimized buying/selling orders from the jobber's computer to computer-equipped trading centers, this happening automatically without human assistance.

This known trading system develops trading strategies as the basis for buying/selling orders of security papers wherein the main focus lies on the trading data of security papers and parameters which bear reference to these trading data. Other data which affect the current value of security papers are merely considered as risk factors. As parameters merely different kinds of orders are mentioned.

A self-trainable automatic process proceeding in real time serves as a drive for the development of these strategies. Thereby various strategies and versions of orders are developed from among which a selection can be chosen (compare on this for example Claims 2 and 3 and FIG. 5). According to which criteria such parameters and strategies are determined and optimized and in which way this learning process takes place cannot be learned from the U.S. 2005/0015323 A1.

### OBJECT OF THE INVENTION

The object underlying the invention is, therefore, to specify a method for automatic trading which considers a wide spectrum of factors affecting the market rate of security papers and executes respective orders immediately on the basis of foreseen anticipated profits without human assistance.

### SUMMARY OF THE INVENTION

This object is accomplished by a method according to Claim 1 and an apparatus according to Claim 11. Advantageous embodiments are described in the dependent claims, which are herewith fully incorporated into the specification.

The main advantage of the method according to the invention lies in the fact that the basis of the sources of information which are accessed in the calculation of the probabilities of rate-relevant developments is considerably broader than in known methods. It has indeed for a long time been known that one of the most important parameters in the development of security prices are the emotional orientation of the people participating in the market, but as yet this fact has hardly been taken into consideration in the automatic analysis of market data.

Outwardly most analysts give indeed the impression of proceeding strictly scientifically in their work, mostly by mathematical methods, but achieve rather unspectacular scores with the hit rate of their forecasts, however. Presumably the human factor, too, plays a role here in such a way that despite the determined mathematical probabilities for rate movements these results are distrusted and an intuitive decision for respective orders is made in the end.

An additional aspect is that in the international stock market, as is known, the stock exchange centers of different nations are involved each with very different religions with different historical backgrounds and moral concepts. However, these different conceptions influence, mostly mechanically, the buying patterns of the respective share holders as well.

A further aspect is the increased occurrence of late of environmental disasters of global extent which plays a role in the analysts' charts but in the fewest cases and if so then mostly too late.

All these factors and a multitude of other factors find regard in the method for automatic trading according to the invention namely with different weighting factors. Since the consideration of this broad basis of rate-relevant data is carried out in real time, converted into buying or selling orders by the machine without human assistance that is without interfering human emotions the commercial success of this method according to the invention is significant in practice as well.

Since in the method according to the invention unlike known methods the volume of the respective trading initiated by the machine is determined as well there is no way here that an order with the tendency of making a profit is restrained as to the size of the profit by emotionally driven thought processes.

The weighting factors preset by the user can nevertheless provide for containing losses.

### DESCRIPTION OF FIGURES

FIG. 1 shows a block diagram of an embodiment of the present invention.

### DETAILED DESCRIPTION OF EMBODIMENTS

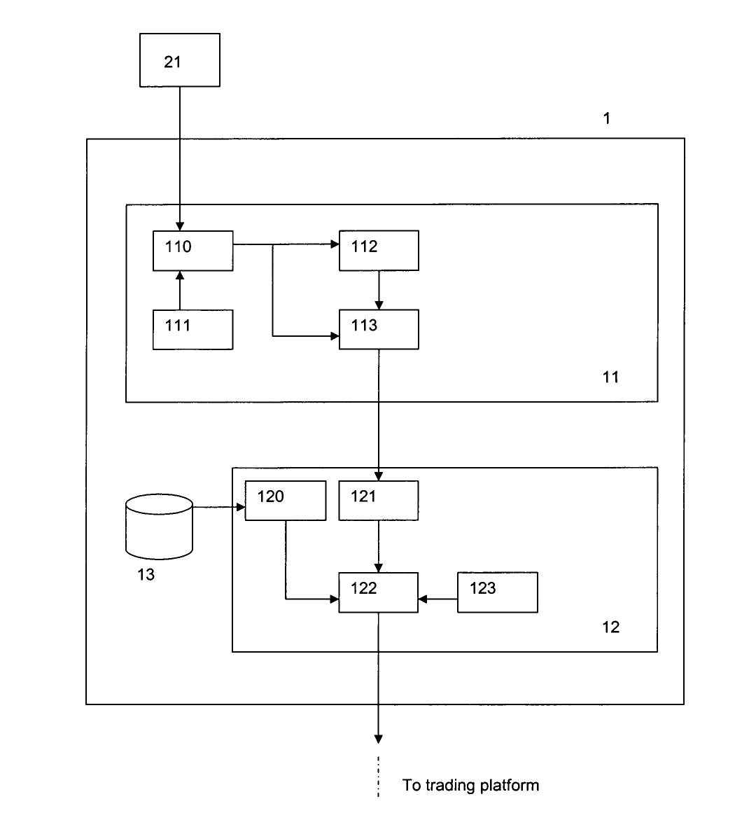

FIG. 1 shows a block diagram of an automatic trading apparatus according to an embodiment of the invention. The apparatus 1 is arranged for automatic trading and comprises a module 11 for generating instructions and an automatic trading module 12. Module 11 comprises a part 110 for receiving one or more forecast or prediction values 21. A forecast value can be any information capable of serving as a basis for a prediction of the course of market. It can e.g. be data from the market on which trading is to take place, or from a different market, or it can be data that is not directly associated with any markets, e.g. meteorological data, quantifiable data relating to politics (e.g. poll results), etc. It can come from any suitable source, e.g. from the Internet and/or dedicated data bases. Each forecast value is associated with a time value in order to provide a time-dependent market forecast function. For example, the time value can come from a local clock 111 in module 11. Naturally, the part 110 may already receive the forecast values linked to a time value, if the values are provided that way from their source.

Module 11 furthermore comprises a part 112 for deriving a trade instruction for a trade from the market forecast function and associating the trading instruction with a trading time value for the indication of a time for the execution of said trading instruction. The trading instruction can e.g. simply be an order to buy, sell or hold a certain tradable commodity, such as a stock, currency etc. The trading time indicates a point in time in the future when the instruction is to be executed, e.g. in so and so many hours from the present time.

Module 11 furthermore comprises a part 113 for generating a weighting factor or weight value in association with said trading instruction, this factor being based on one or more weighting-determining factors in association with said forecast function. The weight-determining factors can e.g. be weights associated with a specific forecast function. If the forecast function f1 is e.g. defined by the temperature values over time (f1(t)) at a given location, then this function might be associated with a weight w1, whereas a different forecast function f2 may be associated with a weight w2. If a trading instruction is derived from f1, then it may receive w1 as its weight. If a trading instruction is derived from f2, then it may receive w2 as its weight. If a trading instruction is derived from f1 and f2, then it may receive the average of w1 and w2 as its weight. Naturally, these are only examples.

The automatic trading module 12 has a part 120 for accessing market-related data in a memory 13. The data are indicative of the state of the market on which the trading takes place, for example they can indicate when the market is open/closed, or can relate to more complicated configurations like typical trading patterns. A part 121 is arranged for determining a volume for the trade indicated by said trading instruction based on said weighting factor. In other words, the part 121 can adjust the volume to a high value if the weighting factor is high, and to a low value if the weighting factor is low. It can be seen that the weighting factor can also be understood as a type or reliability information that expresses an amount of confidence that can be placed into the order associated with the trading instruction.

Finally, module 12 also comprises a part 122 for making out a decision for the execution of a trade which is based on the market-related data from part 120, the trading instruction and the time value, and automatically executing said trading instruction at the time given by the time value in the determined volume in case the decision is positive. The execution can e.g. be performed in known ways using established electronic trading platforms.

It is noted that on account of the two-part structure, one instruction module 11 may co-operate with a plurality of trading modules 12, and one trading module 12 may co-operate with a plurality of instruction modules 11. It is also noted that the modules may be provided within a common entity as indicated by reference numeral 1 in FIG. 1, but this is not necessary, as the modules may also be completely separate.

Furthermore, it is noted that the modules will typically be provided by software running on suitable processors. As such the parts 110-113 and 120-123 can typically be program code parts having designated functionalities. However, it is pointed out that the apparatus and modules can be provided as hardware, software or any suitable combination thereof.

In detail, a trading system according to the invention e.g. operates as follows:

Headlines of news papers and journals and relevant articles are recorded from the internet in real time and used for various other processing purposes. So, in these other processing steps the basic opinions, attitudes and moods of the authors of the recorded articles are determined and in further processing steps the specific environment of the respective organ and historical concerns and sensitivities of the respective nation, which are often based on historical events and existing political circumstances, are considered.

From this result a reflection of the mood, altogether in real time, of the respective economic structure as well as later then by means of linkages with specific known economy-relevant data a forecast function and herefrom indications for buying or selling recommendations.

In this context the system for automated linguistic handling CYC could be used. CYC (from English encyclopedia) is a knowledge data base of everyday knowledge. It is being constantly advanced since 1984. The main application of CYC lies in the area of artificial intelligence. CYC consists of a mass of simple rules (e.g. that water makes wet) which are to make it possible to impart some “common sense” in the form of a program to a computer. For example, with the assistance of the CYC ontology a program is able to conclude from the statement that Peter swims in the ocean and that the ocean consists mostly of water that the individual concerned is wet. Since despite the application of as objective as possible criteria the recommendations thus determined do frequently not cover the real facts on which a buying or selling decision will eventually be based accurately enough, the described procedure will be repeated under at least three further aspects. As further aspects the appraisal of the recorded facts from the perspective of other nations and religions, for example, come into consideration here.

Furthermore, natural disasters happening just now, armed conflicts breaking out as well as the sudden death of a well-known person, respected or hated worldwide, may have a direct effect on the market value of security papers in a way that is unpredictable by mathematical models.

Since people are still affected by superstitious conceptions in many parts of the world, special planetary constellations or aspects in the fields of astrology or astronomy may be taken into consideration as well.

Different such forecast functions have different weight for making a forecast on a market. Hence the invention uses a part or step of weight value generation, in order to classify different trading instructions derived from different forecast functions. Here, the definition of respective weighting factors may be made on the basis of empirically established figures. The more different weighting-determining factors have been considered in a particular trading instruction the more the market forecast based hereon is to be assessed as reliable.

By the term “market” as it is particularly used in the specification and claims a market is to be understood in a very broad and comprehensive way. Not only an actual market, i.e. a collection of rates and market values, is to be understood as a market, but also the notation or value of a single security paper or the current market value of a share or of another tradable value. Generally the market forecast is recorded in the representation of a mathematical curve which may have a continuous progression or may oscillate by a defined value or a limiting curve. If it results from the analysis and the discussion of such a curve progression, respectively, that the margin of fluctuation of an oscillating curve progression or the oscillator frequency fluctuates too heavily or too frequently within a defined time interval the respective weighting-determining factor may be scaled down.

The measure for such a reliability of the weighting-determining factors as well as of the market forecast will be recorded in the method according to the invention and can be output to a user if required.

Basically the method according to the invention and the apparatus according to the invention, respectively, is distinguished by a two-part structure that is not given in the nearest state of the art as it is expressed by the U.S. 2005/0015323 A1, namely the division into an instruction generator and a trading module. The use of weighting factors can also not be taken from this state of the art.

The instruction generator and the module for generating instructions, respectively, works constantly, that is it generates trading instructions continuously from one or more market forecast functions for defined dates in the near or long term future. This means the module does not work in a batch mode wherein, for example, the entire data of one trading day are appraised and processed not until the next day, in order to derive from this defined prognoses for the forthcoming or current trading to be carried out. The advantage of this approach lies in the fact that the method according to the invention becomes independent from enforced interruptions of the normal trading business. This too is in line with the global character of the existing trading system, since there is definitely a stock exchange open at any time somewhere in the world.

The module for generating instructions works preferably in that way that a specific “strategy” is applied to a predictor function f(t), a strategy being understood as a set of specific rules which derive a trading instruction from one or more values of f(t). For example, when f(t) shows a specific behavior (e.g. f (t+Δt)≧2*f(t)) within a time period Δt (for example one hour) then a trading instruction given in accordance with the behavior of f(t) may be issued for a specific future date (e.g. t+ΔT1, ΔT1 being twice as large as ΔT). This may be the purchase of a share, for example. Here, the strategy supplies a form, being composed in a mathematical form, of a specific context. Here, the case described above may serve as an example namely that in the given behavior a rise is to be anticipated after a specific delay. Therefore, in this case one tries to buy the respective share just prior to the forecasted rise. As an example for a weighting function occurring in practice it is pointed out that time itself may be a weighting factor.

If one considers the example of the daytime temperature in New York and the share prices of respective beverage producers, which example will be referred to later as well, it is clear that the time of day in New York may be such a weighting factor. Because at midnight, a time at which the outside temperature is mostly very low, fewer people will suffer under the heat and will, therefore, also concern themselves less with refreshing beverages and their producers, respectively. Here, the weighting factor would have to be set at nearly zero. It is an entirely different case when the outside temperature reaches its peak at noon time. Here in this case the weighting factor would have to be set at its maximum value.

As a further example the shape of the curve which describes the mathematical progression of the function f(t) may itself be taken as a means for attaining a weighting factor. For example, when this curve fluctuates heavily, i.e. when the time derivative fluctuates heavily within a given time period, the reliability of the significance of the respective matter is lower, which means that the weighting factor may also be lower.

It is an entirely different case when the curve progression of the function f(t) shows a continuous clear development in a longer time period. Correspondingly the weighting factor may be set much higher here. Whereas it is understood that the duration of the time period during which the observed curve trend continues already is to be considered as a further weighting factor. In this context it is pointed out that the weighting factors are generally relative values, of course.

In order to be able to process the various weighting factors determined in the same way on the trading module's level these may, therefore, be taken from a defined uniform scale. For example, a scale with relative values between zero and 10 as well as an open-ended scale are conceivable. At this juncture zero would represent the least weighting and 10 the highest. In this way, it can be ensured that the various trading instructions which are issued out from the instruction generating module (or are issued from various instruction generating modules) can be conveyed to a comparable further processing.

Should for particular reasons charts with a subtler classification of the weighting factors be used the reference to the chart normally in use is to be established by means of a compatibility chart.

Further, it is pointed out that in normal operation a module for generating instructions preferably observes several market forecast functions in order to issue a multitude of trading instructions. It is also preferably intended that a multitude of application generating modules can work in parallel in order to pass a respectively large number of trading instructions to the trading module in turn. Here, the modularity of the inventive concept appears advantageous since instruction generating modules are respectively added, modified or taken off again continually without interfering with the operation of the trading module.

As an example for the forecast function and a predictor function f(t), respectively, the outside temperature in New York may be considered. At this juncture it is conceivable that a connection is empirically established between this outside temperature and the share price of specific beverage producers at the New York Stock Exchange. This is an oversimplified example, but it reveals how a forecast function in the form of an arbitrary, simple or complicated mathematical relation f(t) establishes a connection between an event, a fact or a tendency throughout the entire realm of human experience and any kind of trading activity. This means that any trading activity may basically be influenced by any parameters brought into a mathematical form. Hence, in the above simple case it can easily be seen that with a foreseeable longer dry period in New York the share prices of specific beverage producers will increase not least of all because the citizens' attention will be focused onto the beverage supply. From one or more predictor functions f(t) a specific strategy can then be derived which leads to a trading instruction in the end.

For the case of inconsistencies occurring between trading instructions, be it that these concern the volume, the order date or a specific security paper, an arbitration module is preferably provided, which performs a second review of the decision-relevant considerations for such cases and then makes a decision which tries to achieve a maximum possible safety in terms of profit maximization or some other criterion. The arbitration module can e.g. be provided between the trading module 12 and the one or more instruction generating modules 11, in order to receive instructions from the instruction generating module(s), arbitrate on the instructions, and then pass the resulting instructions to the trading module. In this case the arbitration module is at the same time a type of pre-processing module that pre-processes the instructions before they reach the trading module.

However, it is noted that an arbitration module can also be provide within one or both of the instructions generating module and the trading module.

Therefore, it may happen, for example, that one trading instruction pleads for buying a specific product, whereas another asks for exactly the opposite, namely for selling the same product.

A similar conflict may occur in case a trading instruction pleads just like another trading instruction for buying or selling a particular product, however, in a considerably different volume. Thus, a trading instruction may call for the purchase of 100 shares but another may recommend the purchase of 1000 shares.

Likewise may a trading instruction demand the immediate purchase of a trading product, whereas another trading instruction may recommend an ordering date 12 hours later for the same purchase.

Likewise one trading instruction, as well as another may indeed plead for the purchase of stocks from the automotive industry, but may prefer a different company.

There are, of course, numerous cases of conflict conceivable as well which result as a combination of the basically conceivable conflicts described. For example, the resolution of such a conflict can then be effected statistically by merely counting how many trading instructions plead for a specific decision and how many trading instruction plead against it and then choosing a majority decision.

Likewise conflicts can be remedied also in that way that such trading instructions are preferred which are based on facts and events which come from the most recent past. Another way is to prioritize such trading instructions which are based on long-term development tendencies.

On the level of the trading module a special “trading strategy” is preferably pursued by which trading instructions are appraised and processed, respectively. Such a “trading instruction” may be contained in a preprocessing module as well.

For example, a trading strategy may consist in waiting for a given number of instructions with respect to a specific market or a specific value before these are carried out. Another trading strategy may also consist in contrawise not accepting any further instructions after a specific number of instructions carried out until a specific time period has elapsed.

The “market-related data” processed in the trading module comprise among others also the time data at which trading is actually possible at the respective stock exchange center. Because no instructions can be carried out while a particular market is closed.

Other market-related data are for example applicable restrictions on trade. For example, a permanently or temporarily existing restriction on volume per trading activity being in force at some market would have to be mentioned here. Other market-related data are the market index, for example. There, the decision on the execution of a trading can resort to specific empirically established figures that are connected therewith, e.g. that one does not make any buyings or sellings in a specific index combination. In this case the decision on the execution of the trading would be negative.

A further module that is optionally available is a so-called trainable module which observes, i.e. registers the trading instructions of the modules for generating trading instructions and then compares them with the actually achieved trading success. The results of this comparison operation can then be considered in the definition of the strategies and/or weighting factors.

The trading system according to an embodiment of the invention can act independently to a large extent. However, a kind of “console” may exist additionally, of course, by which the user of the automatic trading system can modify or block individual parameters, strategies or also trading instructions.

1. Method for automatic trading comprising
in a module for generating instructions:
a) receiving a multitude of forecast values of a market, wherein
each forecast value is associated with a time value in order to provide a time-dependent market forecast function,
b) deriving a trading instruction for a trade from the market forecast function and associating said trading instruction with a trade time value for the indication of a time for the execution of said trading instruction,
c) generating a weighting factor in association with said trading instruction, this factor being based on one or more weighting-determining factors associated with said forecast function,
in an automatic trading module:
d) accessing market-related data in a memory indicative of the state of the market on which the trading takes place,
e) determining a volume for the trade indicated by said trading instruction based on said weighting factor,
f) making out a decision for the execution of a trading which is based on said market-related data, said trading instruction and said time value, and automatically executing said trading instruction at the time given by the time value in the determined volume in case the decision is positive.

2. Method according to claim 1,
wherein
said one or more weighting-determining factors comprise a reliability-indicating value which indicates the reliability of the forecast of said market forecast function.

3. Method according to claim 2,
wherein
said reliability-indicating value is time-dependent.

4. Method according to claim 3,
wherein
said reliability-indicating value is the time.

5. Method according to claim 2,
wherein
each market forecast value is associated with a reliability-indicating value.

6. Method according to claim 1,
wherein
the one or more weighting-determining factors comprise a value which is derived from the analysis of the market forecast function.

7. Method according to claim 1,
wherein
said module for generating instructions is equipped for receiving market forecast values for a multitude of different market forecast functions, and said step for deriving a trading instruction includes a derivation of a trading instruction from each market forecast function.

8. Method according to claim 1,
wherein
an arbitration module is provided which is provided to resolve conflicts between mutually contradictory trade instructions.

9. Method according to claim 1,
wherein
it includes preprocessing in a preprocessing module of the trading instructions which occur in said module for generating instructions prior to the processing of said trading instructions in said automatic trading module.

10. Method according to claim 1,
wherein
the preprocessing module preferably includes the arbitration module.

11. Apparatus for automatic trading comprising
a module for generating instructions arranged for
a) receiving a multitude of forecast values,
wherein
each forecast value is associated with a time value in order to provide a time-dependent market forecast function,
b) deriving a trade instruction for a trade from the market forecast function and associating said trading instruction with a trading time value for the indication of a time for the execution of said trading instruction,
c) generating a weighting factor in association with said trading instruction, this factor being based on one or more weighting-determining factors in association with said forecast function, and
an automatic trading module arranged for:
d) accessing market-related data in a memory that are indicative of the state of the market on which the trading takes place,
e) determining a volume for the trade which is indicated by said trading instruction based on said weighting factor,
f) making out a decision for the execution of a trading which is based on said market-related data, said trading instruction and said time value, and automatically executing said trading instruction at the time given by the time value in the determined volume in case the decision is positive.

12. Apparatus according to claim 11,
wherein
said one or more weighting-determining factors comprise a reliability-indicating value which indicates the reliability of the forecast of said market forecast function.

13. Apparatus according to claim 11,
wherein
said one or more weighting-determining factors include a reliability-indicating value which indicates the reliability of the forecast of said market forecast function.

14. Apparatus according to claim 13,
wherein
said reliability-indicating value is time-dependent.

15. Apparatus according to claim 14,
wherein
said reliability-indicating value is the time.

16. Apparatus according to claim 12,
wherein
each market forecast value is associated with a reliability-indicating value.

17. Apparatus according claim 11,
wherein
the one or more weighting-determining factors comprise a value which is derived from the analysis of the market forecast function.

18. Apparatus according to claim 11,
wherein
said module for generating instructions is equipped for receiving market forecast values for a multitude of different market forecast functions, and said step for deriving a trading instruction includes a derivation of a trading instruction from each market forecast function.

19. Apparatus according to claim 11,
wherein
an arbitration module is provided which is installed to resolve conflicts between mutually contradictory trade instructions.

20. Apparatus according to claim 11,
wherein
it includes a preprocessing module for preprocessing of the trading instructions which occur in said module for generating instructions prior to the processing of said trading instructions in said automatic trading module.

21. Apparatus according to claim 11,
wherein
the preprocessing module preferably includes the arbitration module.
